(19) United States
(12) Patent Application Publication
(10) Pub. No.: US 2020/0290334 A1
(43) Pub. Date: Sep. 17, 2020

(54) METHOD FOR MANUFACTURING AUTOMOTIVE GLASS WITH MEMBER, AND SUPERHEATED STEAM CHAMBER USED IN MANUFACTURING OF AUTOMOTIVE GLASS WITH MEMBER

(71) Applicant: HORI GLASS CO., LTD., Kanagawa (JP)

(72) Inventors: Tadashi YAMAMOTO, Osaka (JP); Toshihiro OYAMA, Osaka (JP); Hiroyuki HARADA, Kanagawa (JP)

(73) Assignee: HORI GLASS CO., LTD., Kanagawa (JP)

(21) Appl. No.: 16/082,065

(22) PCT Filed: Mar. 2, 2017
(86) PCT No.: PCT/JP2017/008317

§ 371 Date: Sep. 4, 2018

(30) Foreign Application Priority Data
Mar. 7, 2016 (JP) 2016-043383

(51) Int. Cl. B32B 37/06; B32B 17/06; B60J 1/00; C09J 5/06

(52) U.S. Cl. CPC B32B 37/06; B32B 17/064; C09J 2475/00; C09J 5/06; B32B 2605/00; B60J 1/00

(57) ABSTRACT

Provided is a method for producing automotive glass with a member having a U-shaped cross section in a highly efficient and space-saving manner. The present invention relates to a method for producing automotive glass with a member by curing an adhesive for bonding an adherend 21 having a U-shaped cross section to an edge portion 20a of automotive glass 20, using a superheated steam generator 1. The superheated steam generator 1 includes a boiler part 2 for generating steam, a superheating unit 3 for superheating steam generated in the boiler part 2, and a superheated steam chamber 10 having a groove portion 111 for covering the edge portion 20a of the automotive glass 20 and including superheated steam ejection portions 12 for ejecting superheated steam supplied from the superheating unit 3. The step of curing the adhesive comprises covering the edge portion 20a of the automotive glass 20 together with the adherend 21, with the groove portion 111 of the superheated steam chamber 10, and spraying superheated steam to the adherend 21 from both sides of automotive glass 20 from the superheated steam ejection portions 12.

### TECHNICAL FIELD

The present invention relates to a method for producing automotive glass with a member, and a superheated steam chamber for use in the production of automotive glass with a member. More particularly, the present invention relates to a method for producing automotive glass with a door glass-fastening holder, and a superheated steam chamber for use in the production of automotive glass with a door glass-fastening holder.

### BACKGROUND ART

It is known that door glass-fastening holders are attached to automotive glass. Various adhesives, such as epoxy-based adhesives, urethane-based adhesives, silicone-based adhesives, and modified silicone-based adhesives, are conventionally used for attaching door glass-fastening holders.

Among these, polyurethane adhesives containing polyurethane as a main component and containing a plasticizer, a filler, a pigment, etc. are widely used as joint materials, sealing materials, adhesives, covering materials, and the like, as well as for direct glazing in bonding automotive glass to an automotive body. Polyurethane adhesives used for such applications are moisture-curable adhesives and classified into one-component moisture-curable adhesives and two-component moisture-curable adhesives, both of which are cured by progress of a crosslinking reaction due to moisture in the air.

Moisture-curable adhesives require a few days for completion of crosslinking in low temperature conditions during winter because of their very slow cure rates. This tendency is more pronounced especially in one-component polyurethane adhesives. Known as a method for hastening curing of such moisture-curable adhesives is a method using a high-temperature aging room. However, 15 hours or more is required even under an environment at a temperature of 30 to 40° C. and at a relative humidity of 55 to 60% RH in order to obtain strength with no problem in practical use. To completely cure the adhesives, 72 hours or more is required in the above environment. It is thus difficult to significantly improve the efficiency in the step of curing the adhesives.

Further, a relatively large area is required to store automotive glass for as long as 15 hours or more. It is thus necessary to provide a large storage area away from the manufacturing line, which poses a problem of increasing the number of transportation steps in the production of automotive glass. In addition, equipment such as an aging room for controlling humidity etc. is needed to cure the adhesives, requiring a large investment in equipment.

In recent years, a technology has been developed to promote curing of an adhesive using superheated steam, as a technology that shortens an aging and drying process after bonding and that enables production in a highly efficient and space-saving manner, using a one-component thermosetting adhesive or an adhesive in which curing is promoted by heat regardless of whether it is a one-component adhesive or a two-component adhesive (Patent Literature 1 etc.).

Door glass-fastening holders having a U-shaped cross section are bonded to automotive glass, in particular, door glass, using an adhesive. However, the portion of door glass to which heat is supplied is only the door glass-fastening holder portion. Thus, use of a large conveyor line as disclosed in Patent Literature 1 requires a large amount of energy. Further, since a heat-resistant metallic belt conveyor is commonly used for such a conveyor line, there is a risk of secondary problems occurring, such as scratches in the glass caused by contact of the metal with the glass.

### CITATION LIST

### Patent Literature

PTL 1: JP2002-069390A

### SUMMARY OF INVENTION

### Technical Problem

An object of the present invention is to provide a method for producing automotive glass with a member having a U-shaped cross section in a highly efficient and space-saving manner, and a superheated steam chamber for use in the production of automotive glass with a member having a U-shaped cross section.

### Solution to Problem

The present inventors found that automotive glass with a member, in particular, automotive glass with a door glass-fastening holder, can be produced by curing an adhesive in a short period of time by a specific method. The present invention has been thus accomplished.

More specifically, the present invention provides a method for producing automotive glass with a member, and a superheated steam chamber for used in the production of automotive glass with a member according to Items 1 to 10 below.

Item 1. A superheated steam chamber for curing an adhesive for bonding an adherend having a U-shaped cross section to an edge portion of automotive glass, the superheated steam chamber comprising:

a main body having a groove portion capable of covering the edge portion of the automotive glass together with the adherend; and

one or more superheated steam ejection portions for ejecting superheated steam toward the groove portion, the one or more superheated steam ejection portions being disposed on both sides of the groove portion.

Item 2. The superheated steam chamber according to Item 1, wherein the groove portion opens downwardly.

Item 3. The superheated steam chamber according to Item 1 or 2, wherein an air curtain and/or a covering curtain is provided at the opening of the main body.

Item 4. A method for producing automotive glass with a member, comprising:

bonding an adherend having a U-shaped cross section to an edge portion of automotive glass using an adhesive; and

curing the adhesive using a superheated steam generator, thereby attaching the adherend to the automotive glass,

the superheated steam generator comprising a boiler part for generating steam, a superheating unit for superheating steam generated in the boiler part, and the superheated steam chamber according to any one of Items 1 to 3 for ejecting superheated steam supplied from the superheating unit,

the adhesive curing step comprising covering the edge portion of the automotive glass together with the adherend, with the groove portion of the superheated steam chamber, and spraying superheated steam to the adherend from both sides of the automotive glass from the superheated steam ejection portions.

Item 5. The method according to Item 4, wherein the superheated steam chamber comprises one or more heaters, and the temperature of the one or more heaters is 120 to 400° C.

Item 6. The method according to Item 4 or 5, wherein the superheated steam is sprayed for 10 to 120 seconds.

Item 7. The method according to any one of Items 4 to 6, wherein the pressure of steam supplied to the superheating unit is 0.1 to 0.3 MPa.

Item 8. The method according to any one of Items 4 to 7, wherein the adherend is a member comprising at least one member selected from the group consisting of polyetherimide, polybutylene terephthalate, polyethylene terephthalate, polycarbonate, polyamide typified by nylon 6 and nylon 66, polyacetal, polyethylene, polypropylene, ABS, and AES.

Item 9. The method according to any one of Items 4 to 8, wherein the adhesive comprises a two-component modified silicone/epoxy adhesive, a one-component curing urethane adhesive, and/or a two-component urethane adhesive.

Item 10. The method according to any one of Items 4 to 9, wherein a primer is applied to an adhesion surface of the adherend and/or an adhesion surface of the automotive glass.

### Advantageous Effects of Invention

The present invention enables an adhesive to be cured in a short period of time without the need for large equipment, thus significantly reducing energy costs and improving work space efficiency in the process of attaching a member having a U-shaped cross section to automotive glass. Accordingly, the process of attaching a member having a U-shaped cross section to automotive glass can be incorporated as a part of the manufacturing line of automobiles, allowing for efficient manufacturing of automobiles. Further, the present invention enables stable quality to be maintained irrespective of, for example, a difference in the curvature of automotive glass or the size and shape of a member to be attached.

### BRIEF DESCRIPTION OF DRAWINGS

FIG. 1 is a block diagram showing the structure of a superheated steam generator according to the present invention.

FIG. 2 is a perspective view showing the structure of a superheated steam chamber in the superheated steam generator of FIG. 1.

FIG. 3 is a side view of the superheated steam chamber of FIG. 2.

FIG. 4 is a side view showing a covering curtain provided at the opening of the superheated steam chamber of FIG. 2.

FIG. 5 is a side view showing an air curtain provided at the opening of the superheated steam chamber of FIG. 2.

FIG. 6 is a perspective view showing another embodiment of the superheated steam chamber according to the present invention.

FIG. 7 is a perspective view showing another embodiment of the superheated steam chamber according to the present invention.

FIG. 8 is a perspective view showing another embodiment of the superheated steam chamber according to the present invention.

FIG. 9 is a front view showing an embodiment of automotive glass with a member according to the present invention.

FIG. 10 is a front view showing another embodiment of automotive glass with a member according to the present invention.

FIG. 11 is a front view showing another embodiment of automotive glass with a member according to the present invention.

FIG. 12 is a perspective view showing an embodiment of an adherend according to the present invention.

FIG. 13 is a perspective view showing another embodiment of an adherend according to the present invention.

FIG. 14 is a perspective view showing the step of bonding an adherend to automotive glass according to the present invention.

### DESCRIPTION OF EMBODIMENTS

### 1. Superheated Steam Generator

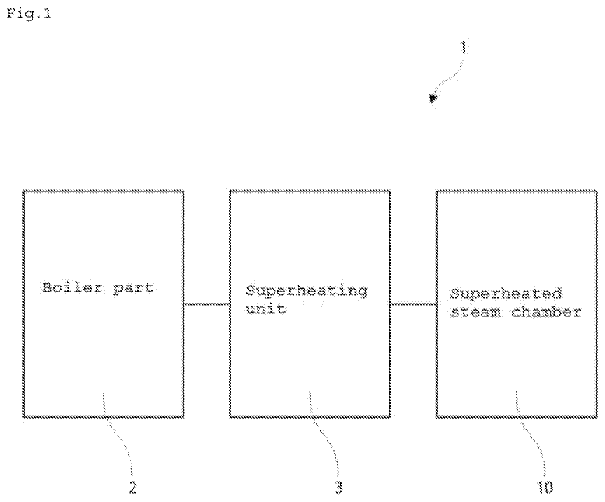

The superheated steam generator 1 according to the present invention is a device for curing an adhesive for bonding an adherend 21 having a U-shaped cross section to an edge portion 20a of automotive glass 20. As shown in FIG. 1, the superheated steam generator 1 includes a boiler part 2 for generating steam, a superheating unit 3 for superheating steam generated in the boiler part 2, and a superheated steam chamber 10 for ejecting superheated steam supplied from the superheating unit to cure the adhesive. The superheating unit 3 is provided so as to be connected to the boiler part 2, and the superheated steam chamber 10 is provided so as to be connected to the superheating unit 3. As the boiler part 2 and the superheating unit 3, any known boiler and superheating unit are used.

### 1.1. Superheated Steam Chamber

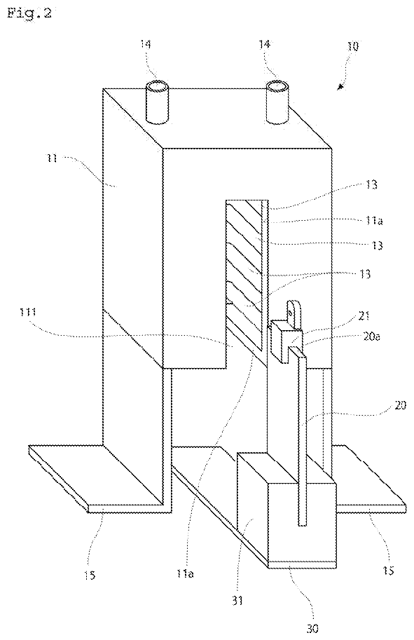

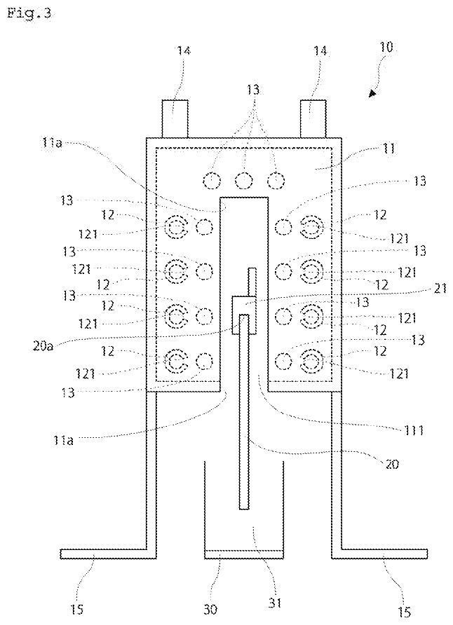

As shown in FIGS. 2 and 3, the superheated steam chamber 10 includes a main body 11, and superheated steam ejection portions 12 and heaters 13 disposed inside the main body 11. In FIGS. 2 and 3, a covering curtain 16 or an air curtain 43, described later, is omitted for simplicity of explanation of an opening 11a of the main body 11. In the following description, the up/down direction is defined based on the view in FIG. 2, and the front/back direction is defined by setting the near side (the side on which the automotive glass 20 etc. are illustrated) in FIG. 2 to the front side. The direction perpendicular to the up/down direction and the front/back direction is defined as the right/left direction.

The main body 11 has a hollow, box-like shape. The material of the main body 11 may be a stainless-steel material or the like from the viewpoint of corrosion resistance. In the main body 11, a groove portion 111 capable of covering the edge portion 20a of the automotive glass 20 together with the adherend 21 is formed. The groove portion 111 opens downwardly to the lower surface of the main body 11 and is upwardly recessed. The groove portion 111 is provided substantially at the center in the right/left direction of the main body 11 and extends through both sides of the main body 11 in the front/back direction. Since the groove portion 111 opens downwardly, water droplets formed by superheated steam in the superheated steam chamber 10 drop outside the superheated steam chamber 10 under their own weight and do not stay in the superheated steam chamber 10, thus preventing the adhesive with which the automotive glass 20 is bonded to the adherend 21 from becoming wet with water droplets.

The superheated steam ejection portions 12 are disposed on both sides (left and right sides) of the groove portion 111 so as to extend in the front/back direction. In this embodiment, the superheated steam ejection portions 12 each having a tubular shape are vertically spaced apart from each other on the left and right sides, four on each side. The superheated steam ejection portions 12 on the left and right sides, four on each side, are provided in pairs in order from the top. Ends (front ends) of each pair of the superheated steam ejection portions 12 are connected with a U-pipe inside the main body 11. The other ends (back ends) of the pair of the superheated steam ejection portions 12 are exposed from side surface portions of the main body 11, and the other ends of the pair of the superheated steam ejection portions 12 are connected to the branched portions of a Y-pipe outside the main body 11. The superheated steam ejection portions 12 are connected to the superheating unit 3 via the Y-pipes, and superheated steam from the superheating unit 3 is supplied to each pair of the superheated steam ejection portions 12. In the superheated steam ejection portions 12, ejection ports 121 are formed for ejecting superheated steam supplied from the superheating unit 3 into the superheated steam chamber 10. Each ejection port 121 may take any shape and opens on the side of the groove portion 111. A plurality of the ejection ports 121 are provided along the longitudinal direction of the superheated steam ejection portions 12.

Heaters 13 are disposed on the side on which the ejection ports 121 of the superheated steam ejection portions 12 are provided (on the side of the groove portion 111). Heaters 13 are also provided above the groove portion 111. Each heater 13 has a tubular shape and has a length in which the heater 13 can be accommodated in the main body 11. In this embodiment, heaters 13 are provided on the left and right sides, four on each side, so as to extend in the front/back direction in parallel to the superheated steam ejection portions 12, and three heaters 13 are provided above the groove portion 111 so as to extend in the front/back direction. As the heaters 13, for example, sheathed heaters are used. The temperature in the superheated steam chamber 10 can be maintained by providing the heaters 13, and the temperature of superheated steam ejected from the ejection ports 121 can also be maintained by providing the heaters 13 on the side at which the ejection ports 121 open.

Exhaust pipes 14 that communicate with the interior of the main body 11 are provided on the upper surface of the main body 11. The exhaust pipes 14 enable steam filling the interior of the main body 11 to be discharged to the outside of the main body 11, adjusting the pressure in the main body 11.

The main body 11 is supported by a pair of leg portions 15 provided on both the left and right sides. Due to the leg portions 15, the main body 11 is held at a height at which the automotive glass 20 with the adherend 21 attached to the edge portion 20a can be inserted into the groove portion 111. Between the pair of leg portions 15, a rail 30 extending in the front/back direction is provided at a position below the groove portion 111. On the rail 30, a pedestal 31 capable of traveling on the rail 30 is provided. The automotive glass 20 is conveyed over the rail 30, with the automotive glass 20 placed on the pedestal 31, and is inserted into the superheated steam chamber 10.

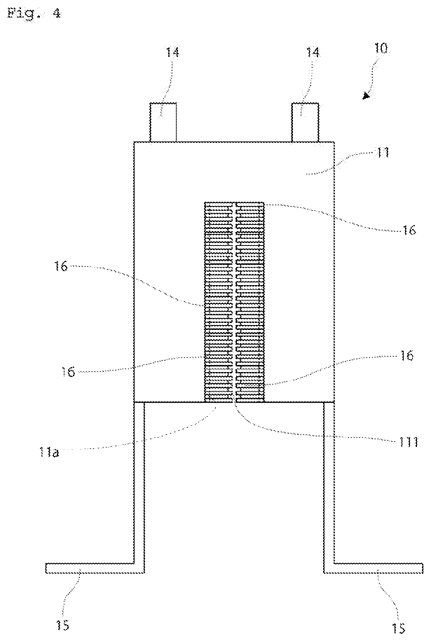

As shown in FIG. 4, a covering curtain 16 is provided at the opening 11a of the groove portion 111 on the lower surface and both side surfaces of the main body 11 (also see FIGS. 2 and 3). The covering curtain 16 includes a plurality of thin columnar or strip-shaped curtain members and is configured by attaching the plurality of curtain members to the opening 11a with no space in a brush-like manner. The curtain members are formed, for example, by processing a cloth-like material of Teflon (registered trademark), Teflon-coated glass fiber, silicone rubber, aramid fiber, or the like into a thin columnar shape or a strip shape. The covering curtain 16 is attached by adhering the edge portions of the covering curtain 16 to the periphery of the opening 11a on wall surfaces forming the main body 11, i.e., the lower surface and side surfaces, by any known means. Attaching the covering curtain 16 to the opening 11a of the main body 11 in such a manner prevents superheated steam inside the main body 11 from escaping from the opening 11a to the outside.

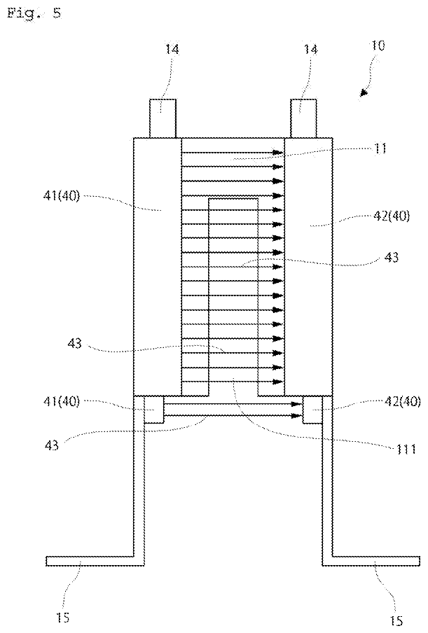

In another embodiment, an air curtain device 40 including an air outlet 41 and an air inlet 42 at opposite sides of the opening 11a on the lower surface and both side surfaces of the main body 11 (also see FIGS. 2 and 3) is attached to the main body 11, as shown in FIG. 5. Air blown from the air outlet 41 of the air curtain device 40 is drawn into the air inlet 42 of the air curtain device 40, thereby generating an air curtain 43 so as to cover the opening 11a. Generating the air curtain 43 at the opening 11a of the main body 11 in such a manner prevents superheated steam inside the main body 11 from escaping from the opening 11a to the outside. The air curtain 43 shown in FIG. 5 may be generated on the covering curtain 16 shown in FIG. 4, with the covering curtain 16 attached to the opening 11a. This enables superheated steam in the main body 11 to be prevented more reliably from escaping from opening 11a to the outside.

The superheated steam chamber 10 may also be configured such that the groove portion 111 does not pass through either side of the main body 11 and such that the main body 11 is not open on either side. In addition, the superheated steam chamber 10 is not limited to an embodiment in which the groove portion 111 opens to the lower surface. The groove portion 111 may be open to a side surface or the upper surface of the main body 11. In this case, the superheated steam ejection portions 12 and the heaters 13 provided inside the main body 11 may be disposed in positions rotated, in accordance with the opening of the groove portion 111, around the front/back direction in which the groove portion 111 extends as an axis.

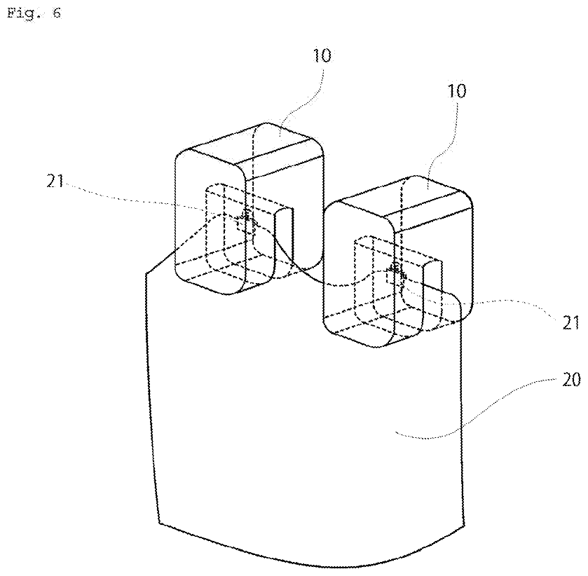

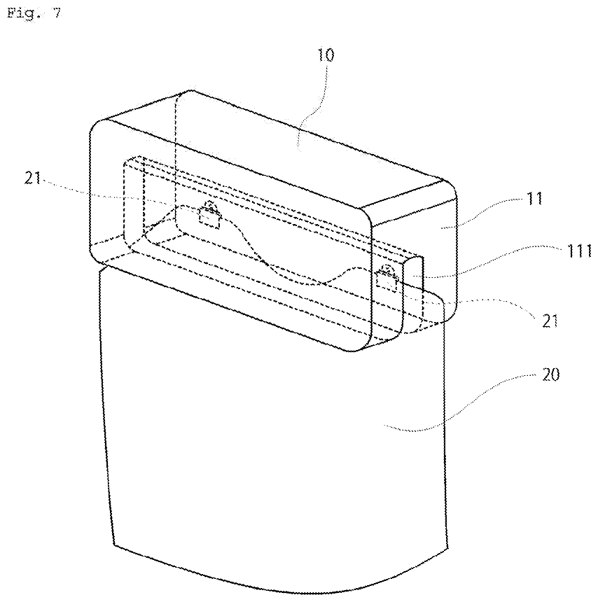

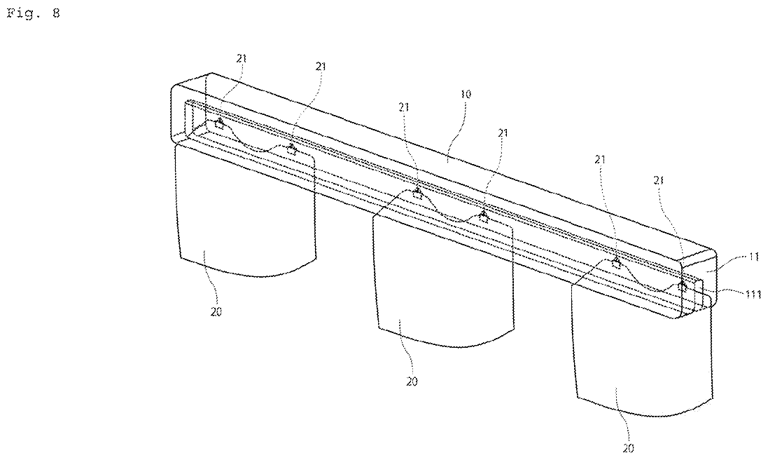

For the superheated steam chamber 10, a single superheated steam chamber 10 may be used, or two superheated steam chambers 10 may be disposed in parallel as shown in FIG. 6 so that adherends 21 in two locations can be attached to the automotive glass 20 at once. Moreover, as shown in FIG. 7, the main body 11 and the groove portion 111 of the superheated steam chamber 10 may be made long so that adherends 21 in two locations can be covered with one superheated steam chamber 10. Further, as shown in FIG. 8, the main body 11 and the groove portion 111 of the superheated steam chamber 10 may be made long so that the adherends 21 of three sheets of automotive glass with members can be covered with one superheated steam chamber 10.

2. Automotive Glass with Member

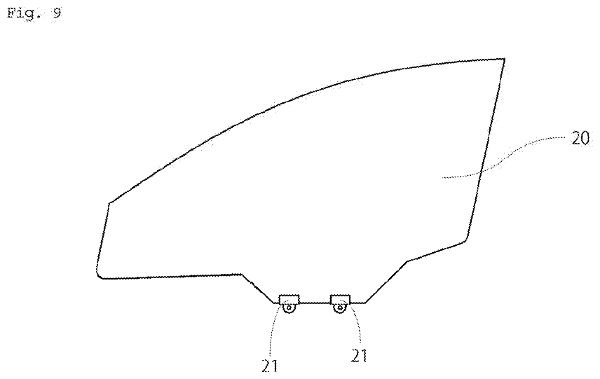

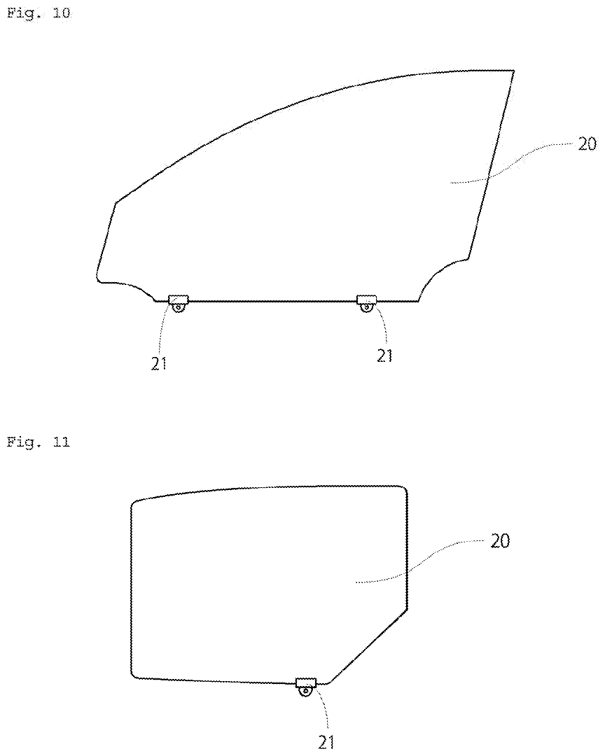

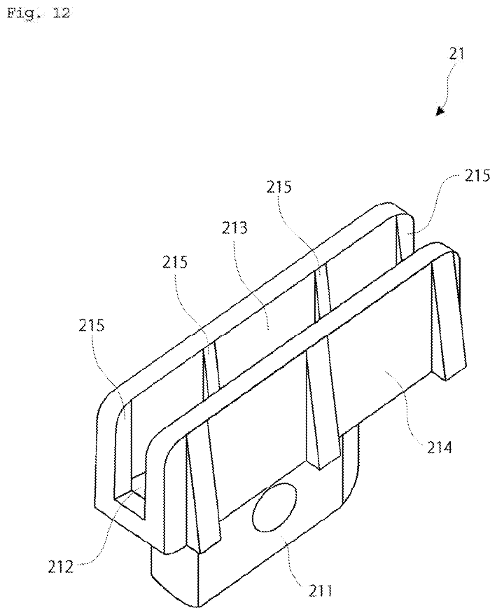

The automotive glass with a member produced by the method of the present invention is automotive glass 20 to which one or more adherends 21 (members) are bonded, as shown in FIGS. 9 to 11. More specifically, one or more adherends 21 are bonded to the automotive glass 20 by using an adhesive.

### 2.1. Automotive Glass

In the present invention, the automotive glass 20 is not particularly limited. Examples include glass for automobiles, such as tempered glass and laminated glass comprising a resin layer of polyvinyl butyral or the like as an intermediate layer. The method of the present invention enables an adhesive to be cured in a short period of time without excessive heating, and is therefore suitable especially for the automotive glass 20, in which a problem occurs due to excessive heating. For example, in the case of tempered glass, untreated glass is subjected to heat treatment, thereby enhancing the surface strength. Thus, if the glass is exposed to excessive temperatures in attaching the adherend 21, such as a door glass-fastening holder, the strength of the glass itself decreases. In the case of laminated glass, when subjected to excessive heating, a resin such as polyvinyl butyral in the interlayer melts and foams, resulting in decline in strength, poor appearance, and like problems. Thus, the method of the present invention, which does not require excessive heating, can suitably be used especially for the automotive glass 20, such as tempered glass and laminated glass.

The automotive glass 20 may be degreased to remove dust and oily components. Degreasing is generally performed with an organic solvent. The organic solvent used for degreasing is not particularly limited. Typical examples of organic solvents include lower-alcohol solvents, such as methanol, ethanol, and isopropyl alcohol, and ketones, such as acetone and methyl ethyl ketone.

### 1.2. Adherend

In the present invention, the adherend 21 refers to a door glass-fastening holder. The shape of the door glass-fastening holder 21 is not particularly limited. The door glass-fastening holder 21 may be a holder in which one side of the holder 21 is to be bonded to the automotive glass 20, may have a holder having a U-shaped cross section to hold the automotive glass 20, or may be a holder that is divided into two. It is particularly preferred that the door glass-fastening holder 21 has a U-shaped cross section. The size of the adhesion surface is not particularly limited, and any size may be selected, taking into consideration the size, weight, and shape of the automotive glass 20.

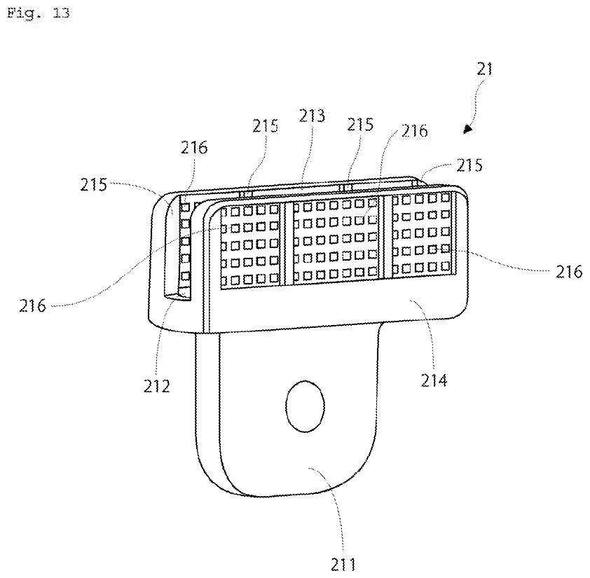

In this embodiment, as shown in FIG. 12, the door glass-fastening holder 21 includes a connecting portion 211 that is to be connected to lifting means for moving the automotive glass 20 up and down, a bottom wall portion 212 extending along the edge portion 20a (lower surface) of the automotive glass 20 from the connecting portion 211, an inner wall portion 213 extending along the inner surface of the automotive glass 20 from the bottom wall portion 212, and an outer wall portion 214 extending along the outer surface of the automotive glass 20 from the bottom wall portion 212. The inner wall portion 213 and the outer wall portion 214 are provided with a plurality of ribs 215 that protrude from the surfaces facing the automotive glass 20 and that form a clearance to be filled with an adhesive between the holder and the automotive glass 20. The plurality of ribs 215 extend in the up/down direction in FIG. 12. The upper center of the outer wall portion 214 is an adhesive filling portion. Filling this portion with an adhesive enables the thickness of the adhesive that accumulates between the holder and the automotive glass 20 to be greater than the height of the plurality of ribs 215.

The clearance between the automotive glass 20 and the door glass-fastening holder 21, i.e., the thickness of an adhesive, is preferably 0.1 mm to 3.0 mm, and particularly preferably 0.2 mm to 1.0 mm. If the thickness of an adhesive is 0.1 mm or less, the cushioning effect is likely to decrease, leading to breaking of the automotive glass 20. If the thickness of an adhesive exceeds 3.0 mm, vibration occurs when the automotive glass 20 moves up and down. As long as the desired clearance between the automotive glass 20 and the door glass-fastening holder 21 can be maintained, the width, number, etc. of the ribs 215 at the adhesion portion of the door glass-fastening holder 21 can be freely selected.

As shown in FIG. 13, the inner wall portion 213 and the outer wall portion 214 of the door glass-fastening holder 21 may be thinned and have a plurality of through holes 216 in order to improve heat-transfer efficiency.

As the material of the adherend (door glass-fastening holder) 21, metal, such as steel, stainless steel, and aluminum, may be used; however, engineering plastics etc., such as polyester resins typified by polybutylene terephthalate and polyethylene terephthalate, polyamide resins, and polyacetal resins, are suitable. Of these, polybutylene terephthalate is most suitable. To increase the strength, the material may contain glass fiber or may be an alloy with, for example, ABS or a polycarbonate. Specific examples of polybutylene terephthalate are polybutylene terephthalate resins. Such polybutylene terephthalate resins are commercially available from Polyplastics Co., Ltd., under the trade name DURANEX, from Mitsubishi Engineering-Plastics Corporation under the trade name NOVADURAN, and from Toray Industries, Inc., under the trade name TORAYCON. The polybutylene terephthalate resins are not limited to these.

The adherend 21 is molded by using known injection molding, but is not limited to this.

The adherend 21 may be degreased before adhesion in order to remove dust or oily components on the adhesion surface. Degreasing is generally performed with an organic solvent. Typical examples of organic solvents include, but are not limited to, lower alcohols, such as methanol, ethanol, and isopropyl alcohol, and ketones, such as acetone and methyl ethyl ketone.

In addition, although there is no particular limitation, a synthetic resin, a polyisocyanate composition, or the like, which is generally called a primer, may be applied to the adhesion surface, or the adhesion surface may be subjected to physical-surface-modifying treatment, such as corona or plasma treatment.

### 2.3. Adhesive

The adhesive of the present invention is, for example, an adhesive the curing of which is promoted by heat. Specific examples include known thermosetting adhesives such as acrylic adhesives, epoxy-based adhesives, urethane-based adhesives, silicone-based adhesives, and modified silicone-based adhesives. These adhesives may be one-component or two-component adhesives. From the viewpoint of use for adhesion between the automotive glass 20 and the adherend 21, two-component modified silicone/epoxy adhesives, one-component thermosetting urethane adhesives, and two-component urethane adhesives, all of which have good results, are preferable. In addition, when the shape of the inner wall portion 213 of the door glass-fastening holder 21 is changed to a shape in which no ribs 215 are provided, for example, an acrylic epoxy resin in the form of a double-sided tape or a film containing a reactive phenolic resin and nitrile rubber as main components can be used as the adhesive.

### 2.3.1. Two-Component Modified Silicone/Epoxy Adhesive

The two-component modified silicone/epoxy adhesive is an adhesive containing an alkoxysilyl-containing polymer, a curing catalyst for the alkoxysilyl-containing polymer, a vinyl-based polymer, an epoxy resin, an epoxy curing agent, and an inorganic filler.

Preferably, the alkoxysilyl-containing polymer substantially has a polyoxyalkylene structure as its main chain and contains at least one member selected from the group consisting of dialkylmonoalkoxysilyl, monoalkyldialkoxysilyl, and trialkoxysilyl as an alkoxysilyl group.

The alkoxysilyl-containing polymer is required to have at least one alkoxysilyl group per molecule. In terms of reactivity, the alkoxysilyl-containing polymer preferably has two or more alkoxysilyl groups, which can impart temporary fixing ability to the adhesive layer quickly. The number of alkoxysilyl groups may be three or four. When the number of alkoxysilyl groups is five or more, the storage stability decreases, and the vibration resistance of the adhesive cured layer becomes insufficient, which is undesirable. Thus, two to four is optimal.

The alkoxysilyl-containing polymer is not particularly limited as long as it is a polymer containing an alkoxysilyl group. A preferable main chain structure of the alkoxysilyl-containing polymer is a polyoxyalkylene structure represented by —(R—O)n-, wherein R is an alkylene group. Examples of alkylene groups include ethylene, propylene, isobutylene, tetramethylene, and the like. Such alkylene groups may coexist. The molecular weight of the alkoxysilyl-containing polymer is preferably about 500 to 30,000 as a number average molecular weight (Mn) from the viewpoint of reactivity and properties after reaction. More preferably, the Mn is 2000 to 20,000.

The alkoxysilyl-containing polymer preferably has at least one of dialkylmonoalkoxysilyl, monoalkyldialkoxysilyl, and trialkoxysilyl, as an alkoxysilyl group. Examples of alkoxy include methoxy, ethoxy, propoxy, and the like. It is particularly preferred that the alkoxysilyl-containing polymer contains monomethyldimethoxysilyl and trimethoxysilyl. The most preferable alkoxysilyl-containing polymer contains both monomethyldimethoxysilyl and trimethoxysilyl. Of course, the alkoxysilyl-containing polymer may be a mixture of polymers having various alkoxysilyl groups, and a mixture of a monomethyldimethoxysilyl-containing silicone polymer and a trimethoxysilyl-containing silicone polymer can preferably be used as an alkoxysilyl-containing polymer containing both monomethyldimethoxysilyl and trimethoxysilyl.

A preferable method for obtaining a polymer having a polyoxyalkylene structure as a main chain structure and containing an alkoxysilyl group is a method in which an alkylene oxide (e.g., ethylene oxide or propylene oxide) is reacted with a polyol, such as a diol (e.g., ethylene glycol or propylene glycol); a triol (e.g., glycerin or hexanetriol); a tetraol (e.g., pentaerythritol or diglycerin); or sorbitol, under known conditions to obtain a polyoxyalkylene polymer, and then an alkoxysilyl group is introduced. Preferable polyoxyalkylene polymers are divalent to hexavalent polyoxypropylene polyols, particularly polyoxypropylene diol and polyoxypropylene triol.

The first method for introducing an alkoxysilyl group into a polyoxyalkylene polymer is a method in which an unsaturated double bond is introduced into the terminal hydroxyl group of a polyoxyalkylene polymer, and then a hydrosilyl compound represented by the formula: HSi(OR¹)₂(R²) and/or HSi(OR¹)₃ (wherein R¹ may be the same or different, and each represents a hydrogen atom or a C₁₋₅ alkyl group, and R² represents a C₁₋₁₀ alkyl group or a C₆₋₂₀ aryl group) is reacted.

An unsaturated double bond can be introduced by, for example, reacting a compound having an unsaturated double bond and a functional group reactive with a hydroxyl group with the hydroxyl group of a polyoxyalkylene polymer to bond them via an ether linkage, an ester linkage, a urethane linkage, a carbonate linkage, or the like. In polymerizing oxyalkylenes, an allyl-containing epoxy compound, such as allyl glycidyl ether, may be added to perform copolymerization, thereby introducing a double bond into the side chain of the polyoxyalkylene polymer.

The hydrosilyl compound described above is reacted with the introduced unsaturated double bond, thereby obtaining an alkoxysilyl-containing polymer into which an alkoxysilyl group is introduced. In the reaction with the hydrosilyl compound, it is recommended to use a platinum-based catalyst, a rhodium-based catalyst, a cobalt-based catalyst, a palladium-based catalyst, or a nickel-based catalyst. Of these, a platinum-based catalyst, such as chloroplatinic acid, platinum metal, platinum chloride, or a platinum olefin complex, is preferable. The reaction with the hydrosilyl compound is preferably performed at 30 to 150° C., particularly 60 to 120° C., for several hours.

The second method for introducing an alkoxysilyl group into a polyoxyalkylene polymer is a method in which an isocyanate silyl compound represented by the formula: R²—Si(OR¹)₂ (R³NCO) and/or (R³NCO)Si(OR)₃ (wherein R¹ and R² are the same as defined above, and R³ is a C₁₋₁₇ divalent hydrocarbon group) is reacted with the hydroxyl group of a polyoxyalkylene polymer. In this reaction, a known urethanization catalyst may be used. The reaction is generally performed at 20 to 200° C., particularly 50 to 150° C., for several hours, thereby obtaining an alkoxysilyl-containing polymer. The third method for introducing an alkoxysilyl group into a polyoxyalkylene polymer is a method in which a polyisocyanate compound, such as tolylene diisocyanate, is reacted with the hydroxyl group of a polyoxyalkylene polymer to introduce an isocyanate group, followed by a reaction with a compound represented by the formula: R²—Si(OR¹)₂(R³W) and/or (R³W)Si(OR¹) (wherein R¹, R², and R³ are the same as defined above, and W is an active hydrogen group selected from hydroxyl, carboxyl, mercapto, primary amino, and secondary amino). An alkoxysilyl-containing polymer can be obtained by reaction of W with the isocyanate group.

As the fourth method, a method may be used in which an unsaturated double bond is introduced into the terminal of a polyoxyalkylene polymer in the same manner as in the first method, followed by a reaction with the compound in the third method in which W is a mercapto group. Examples of such compounds include 3-mercaptopropylmethyldimethoxysilane, 3-mercaptopropyltrimethoxysilane, 3-mercaptopropyltriethoxysilane, and the like. In the reaction, a polymerization initiator, such as a radical generator, may be used. In some cases, the reaction may be performed using radiation or heat without using a polymerization initiator.

As polymerization initiators, peroxide-based polymerization initiators, azo-based polymerization initiators, redox-based polymerization initiators, metal compound catalysts, and the like can be used. Polymerization initiators having a reactive silicon functional group can also be used as peroxide-based polymerization initiators or azo-based polymerization initiators. Specific examples include benzoyl peroxide, tert-alkyl peroxyesters, acetyl peroxide, diisopropyl peroxycarbonate, 2,2′-azobis(2-isobutyronitrile), 2,2′-azobis(2-methylbutyronitrile), 2,2′-azobis(2-methyl-4-trimethoxysilylpentonitrile), 2,2′-azabis(2-methyl-4-methyldimethoxysilylpentonitrile), and the like. The reaction in the fourth method is preferably performed at 20 to 200° C., particularly 50 to 150° C., for several hours to several tens of hours.

As the polymer having a polyoxyalkylene structure as a main chain structure and containing an alkoxysilyl group, a polymer commercially available as a modified silicone polymer may be used. Examples include commercially available products, such as the trade name Silyl SAT200 (produced by Kaneka Corporation), which has a monomethyldimethoxysilyl group as a terminal structure.

The two-component modified silicone/epoxy adhesive contains a curing catalyst for the alkoxysilyl-containing polymer. The curing catalyst plays a role in promoting hydrolysis condensation polymerization reaction of the alkoxysilyl group. Although this reaction proceeds only with moisture in the air, it is recommended to use, for example, an organotin compound, a metal complex, a basic compound, or an organophosphorus compound as a curing catalyst in order to accelerate the reaction progress. The amount of the curing catalyst is preferably 0.01 to 10 parts by mass per 100 parts by mass of the alkoxysilyl-containing polymer of the two-component modified silicone/epoxy adhesive.

Specific examples of organotin compounds include dibutyltin dilaurate, dibutyltin dimaleate, dibutyltin phthalate, stannous octylate, dibutyltin methoxide, dibutyltin diacetylacetate, dibutyltin diversatate, dibutyltin oxide, and reaction products of dibutyltin oxide and phthalic acid diester. Examples of metal complexes include titanate compounds, such as tetrabutyl titanate, tetraisopropyl titanate, and triethanolamine titanate; carboxylic acid metal salts, such as lead octylate, lead naphthenate, nickel naphthenate, cobalt naphthenate, bismuth octylate, and bismuth versatate; metal acetylacetonate complexes, such as aluminum acetylacetonate complexes and vanadium acetylacetonate complexes; and the like.

Examples of basic compounds include aminosilanes, such as γ-aminopropyltrimethoxysilane and γ-aminopropyltriethoxysilane; quaternary ammonium salts, such as tetramethylammonium chloride and benzalkonium chloride; DABCX (registered trademark) series produced by Sankyo Air Products Co., Ltd. and DABCO BL series produced by Sankyo Air Products Co., Ltd.; straight-chain or cyclic tertiary amines and quaternary ammonium salts containing a plurality of nitrogen atoms, such as 1,8-diazabicyclo[5.4.0]undec-7-ene; and the like.

Examples of organophosphorus compounds include monomethyl phosphoric acid, di-n-butyl phosphoric acid, triphenyl phosphate, and the like.

The two-component modified silicone/epoxy adhesive contains a vinyl-based polymer as an essential component. Although the reason is not clear, the vinyl-based polymer has an action of promoting hydrolysis condensation polymerization reaction of the alkoxysilyl group. Examples of monomers forming the vinyl-based polymer include (meth)acrylic acid; (meth)acrylates that are C₁₋₂₀ alkyl esters, such as methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, n-hexyl (meth)acrylate, 2-ethylhexyl (meth)acrylate, dodecyl (meth)acrylate, tetradecyl (meth)acrylate, hexadecyl (meth)acrylate, and octadecyl (meth)acrylate; (meth)acrylates, such as cyclohexyl (meth)acrylate, benzyl (meth)acrylate, phenyl (meth)acrylate, isobornyl (meth)acrylate, dimethylaminoethyl (meth)acrylate, tert-butylaminoethyl (meth) acrylate, glycidyl (meth) acrylate, tetrahydrofuran (meth)acrylate, allyl (meth)acrylate, 2-hydroxyethyl (meth)acrylate, hydroxypropyl (meth)acrylate, 2-hydroxy-3-phenoxypropyl (meth) acrylate, trimethylolpropane tri(meth)acrylate, trifluoroethyl (meth)acrylate, trade names M-110 and M-111 produced by Toagosei Co., Ltd., and trade names VeoVa 9 and VeoVa 10 produced by Shell Chemicals; acrylonitrile, α-methylacrylonitrile; 2-(meth)acryloyloxyethyl succinate, 2-(meth)acryloyloxyethyl maleate, 2-(meth)acryloyloxyethyl phthalate, 2-(meth)acryloyloxyethyl hexahydrophthalate; (meth)acrylamide; acrylic monomers, such as (meth)acrylic glycidyl ether; styrenic monomers, such as styrene, vinyltoluene, divinylbenzene, α-methylstyrene, o-methylstyrene, m-methylstyrene, p-methylstyrene, p-ethylstyrene, and p-methoxystyrene; vinyl-containing monomers, such as vinyl chloride, vinyl acetate, vinyl propionate, vinylpyrrolidone, vinylcarbazole, vinyl ether, and vinyl glycidyl ether; allyl-containing monomers, such as allyl glycidyl ether; 2,4-dicyanobutene-1, butadiene, isoprene, chloroprene, and other olefins or halogenated olefins; unsaturated esters; and the like. These may be used singly or in a combination of two or more.

From the viewpoint of improving the vibration resistance and heat resistance of the adhesive layer, a monomer whose homopolymer has a Tg of 0 to 200° C. is preferably selected. Examples of such monomers include methyl methacrylate, ethyl methacrylate, n-propyl methacrylate, isopropyl methacrylate, n-butyl methacrylate, isobutyl methacrylate, sec-butyl methacrylate, tert-butyl methacrylate, n-hexadecyl methacrylate, n-octadecyl methacrylate, cyclohexyl (meth)acrylate, benzyl (meth)acrylate, phenyl (meth)acrylate, isobornyl (meth)acrylate, dimethylaminoethyl (meth) acrylate, tert-butylaminoethyl (meth) acrylate, glycidyl methacrylate, tetrahydrofuran (meth)acrylate, allyl methacrylate, 2-hydroxyethyl methacrylate, hydroxypropyl methacrylate, 2-hydroxy-3-phenoxypropyl (meth) acrylate, trimethylolpropane tri (meth) acrylate, trifluoroethyl (meth)acrylate, trade names M-110 and M-111 produced by Toagosei Co., Ltd., trade names VeoVa 9 and VeoVa 10 produced by Shell Chemicals, trifluoroethyl methacrylate, acrylonitrile, 2-methacryloyloxyethyl succinate, 2-methacryloyloxyethyl maleate, 2-methacryloyloxyethyl phthalate, 2-methacryloyloxyethyl hexahydrophthalate, styrene, α-methylstyrene, o-methylstyrene, m-methylstyrene, p-methylstyrene, p-ethylstyrene, p-methoxystyrene, vinyl chloride, vinylpyrrolidone, vinylcarbazole, and the like. Of these, one, or two or more monomers selected from methyl methacrylate, glycidyl methacrylate, acrylonitrile, and styrene are preferable. More preferably, two or more of these monomers are used in combination.

In synthesis of the vinyl-based polymer, an alkoxysilyl-containing monomer can also be used. Specific examples include vinylmethyldimethoxysilane, vinylmethyldiethoxysilane, vinyltrimethoxysilane, tris (2-methoxyethoxy) vinylsilane, 3-(meth)acryloyloxypropylmethyldimethoxysilane, 3-(meth)acryloyloxypropyltrimethoxysilane, and the like. Of these, 3-(meth)acryloyloxypropylmethyldimethoxysilane and 3-(meth)acryloyloxypropyltrimethoxysilane are preferable. These alkoxysilyl-containing monomers are preferably used in combination with the monomers mentioned above. The amount of the alkoxysilyl-containing monomer is preferably 0.01 to 10 mass % based on 100 parts by mass of the monomer component for synthesizing the vinyl-based polymer.

The vinyl-based polymer can be obtained by polymerizing the above monomer by a known method such as radical polymerization, anion polymerization, or cationic polymerization. The polymerization may be performed in the presence of a solvent such as xylene, toluene, acetone, methyl ethyl ketone, ethyl acetate, or butyl acetate. After the completion of the polymerization, if necessary, such a solvent may be removed by a method such as distillation under reduced pressure, and then the polymer may be mixed with, for example, an alkoxysilyl-containing polymer or an epoxy resin. However, the step of distilling the solvent off is complicated; therefore, a method for polymerizing a monomer component for a vinyl-based polymer in the presence of an alkoxysilyl-containing polymer mentioned above is recommended because a mixture of both components can easily be obtained.

In particular, preferred is a radical polymerization method performed in the presence of an azo-based polymerization initiator or a peroxide-based polymerization initiator. Examples of azo-based polymerization initiators include 2,2′-azobis(2-isobutyronitrile), 2,2′-azobis(2-methylbutyronitrile), 2,2′-azobis (2,4-dimethylvaleronitrile), 2,2′-azobis (2-methyl-4-trimethoxysilylpentonitrile), 2,2′-azobis (2-methyl-4-methyldimethoxysilylpentonitrile), and trade names VA-046B, VA-057, VA-061, VA-085, VA-086, VA-096, V-601, V-65, and VAm-110 produced by Wako Pure Chemical Industries, Ltd. Examples of peroxide-based polymerization initiators include benzoyl peroxide, tert-alkyl peroxyesters, acetyl peroxide, and diisopropyl peroxycarbonate. In this case, the polymerization may be performed in the presence of a chain transfer agent such as lauryl mercaptan, γ-mercaptopropyltrimethoxysilane, γ-mercaptopropylmethyldimethoxysilane, thio-β-naphthol, thiophenol, n-butyl mercaptan, ethyl thioglycolate, isopropyl mercaptan, t-butyl mercaptan, or γ-trimethoxysilylpropyl disulfide.

In addition, modified silicone polymers, which are mixtures of an alkoxysilyl-containing polymer and a vinyl-based polymer, are already marketed under trade names such as ES-GX3406a (produced by Asahi Glass Co., Ltd.), Silyl MA440, Silyl MA447, and Silyl MA430 (all produced by Kaneka Corporation). These products can be used.

The two-component modified silicone/epoxy adhesive contains an epoxy resin and an epoxy curing agent. The epoxy resin is three-dimensionally cured with an epoxy curing agent and thus has a role in enhancing the heat resistance of the adhesive layer and adhesion to glass. Examples of epoxy resins include known bisphenol-type epoxy resins; biphenyl-type epoxy resins; alicyclic epoxy resins; multifunctional glycidyl amine resins such as tetraglycidylaminodiphenylmethane; multifunctional glycidyl ether resins such as tetraphenylglycidyletherethane; phenol novolac-type epoxy resins, cresol novolac-type epoxy resins, and the like. Various grades of epoxy resins are commercially available, and thus such products can be used. From the viewpoint of workability, bisphenol A-type liquid resins that have a molecular weight of about 300 to 500 and that are liquid at ordinary temperature are preferable.

The epoxy curing agent is not particularly limited as long as it is a commonly used curing agent. Examples of usable curing agents include amines, such as triethylenetetramine, diethylenetriamine, meta-xylylenediamine, meta-phenylenediamine, diaminodiphenylmethane, isophoronediamine, and 2,4,6-tris (dimethylaminomethyl)phenol; tertiary amine salts; polyamide resins; imidazoles; and carboxylic anhydride, such as phthalic anhydride; and like compounds. In particular, in the two-component modified silicone/epoxy adhesive, it is preferable to use an aliphatic amine-based curing agent with which curing reaction takes place relatively quickly. A latent curing agent, such as ketimine, in which active amine is blocked and activated by moisture in the air, may also be used. The epoxy curing agent may be used in an amount of 0.1 to 300 parts by mass per 100 parts by mass of the epoxy resin.

The inorganic filler adjusts the viscosity and structural viscosity index of the adhesive before curing, acts as an extender, and has an action of enhancing the strength and heat resistance of the adhesive cured layer as a reinforcing agent. The inorganic filler is preferably a powdered material of calcium carbonate, silica, titanium dioxide, talc, mica, or the like. As calcium carbonate, colloidal calcium carbonate and heavy calcium carbonate are usable.

The components described above are essentially contained, and it is preferred that the amount of the vinyl-based polymer is adjusted in the range of 1 to 200 parts by mass, the amount of the epoxy resin is adjusted in the range of 30 to 70 parts by mass, and the amount of the inorganic filler is adjusted in the range of 10 to 300 parts by mass, per 100 parts by mass of the alkoxysilyl-containing polymer. If the amount of the vinyl-based polymer is too small, the action of promoting hydrolysis condensation polymerization reaction of the alkoxysilyl group is not exerted, whereas if the amount of the vinyl-based polymer is too large, the excellent vibration resistance of the alkoxysilyl-containing polymer may be impaired. If the amount of the epoxy resin is too small, the final adhesion strength, heat resistance, chemical resistance, etc. of the adhesive cured layer may be insufficient, whereas if the amount of the epoxy resin is too large, the vibration resistance may decrease. If the amount of the inorganic filler is too small, the viscosity of the adhesive before curing may be below the intended value and thus may cause a problem such as sagging, whereas if the amount of the inorganic filler is too large, workability is reduced.

In such an adhesive, curing reaction of the alkoxysilyl-containing polymer is initiated by moisture in the air; therefore, the components are preferably mixed immediately before use. In mixing, it is preferable to avoid contact with moisture in the air in order to obtain a stable cure rate irrespective of the external environment. For example, it is recommended to mix the components while blocking air by using a static mixer or the like.

In view of the pot life and shortening of mixing time, a two-component adhesive may be used, and the two components may be mixed immediately before use. If the two-component modified silicone/epoxy adhesive is divided into an agent A and an agent B, for example, the alkoxysilyl-containing polymer is incorporated into the agent A, the curing catalyst for the alkoxysilyl-containing polymer is incorporated into the agent B, the epoxy resin is incorporated into the agent B, and the epoxy curing agent is incorporated into the agent A, thereby increasing the pot life. When a commercially available vinyl-based polymer in the form of a mixture with an alkoxysilyl-containing polymer is used as the vinyl-based polymer, the vinyl-based polymer is contained in the agent A. However, a vinyl-based polymer may be separately synthesized and incorporated into the agent B. The inorganic filler may be incorporated into either the agent A or the agent B, or into both. Incorporating the inorganic filler into both the agent A and the agent B so that the agent A and the agent B have the same degree of viscosity is preferable in terms of ease of mixing both agents. When the agent A and the agent B are each prepared, known mixing means such as a planetary mixer can be used.

Such adhesives are marketed under the trade names MOS (registered trademark) 200 and MOS (registered trademark) 300 from Konishi Co., Ltd.

### 2.3.2 One-Component Curing Urethane Adhesive

Examples of one-component curing urethane adhesives include adhesives containing an amine-based latent curing agent and a curing catalyst and adhesives containing an isocyanate compound encapsulated in microcapsules. Although there is no limitation, adhesives containing an isocyanate compound encapsulated in microcapsules are preferable. The temperature at which the shells of the microcapsules dissolve is particularly preferably about 80 to 120° C. If the temperature is 80° C. or less, the adhesive may degrade or undergo change over time during storage in the living environment, whereas if the temperature is 120° C. or more, damage to an adherend may occur in curing.

The polyurethane composition may contain a filler, a plasticizer, an antioxidant, a pigment, a silane coupling agent, a dispersing agent, a solvent, etc.

Examples of fillers include calcium carbonate, silica, and the like. Calcium carbonate is classified broadly into heavy calcium carbonate and precipitated calcium carbonate. In order to prevent reaction of the isocyanate group with moisture to improve storage stability, precipitated calcium carbonate whose surface is treated with a fatty acid ester is preferable.

The fatty acid and ester of the fatty acid ester used for the surface treatment of calcium carbonate are not limited. Examples include stearic acid stearate, stearic acid laurate, palmitic acid stearate, and palmitic acid laurate. Esters obtained from monohydric alcohols are also useful. The amount of fatty acid ester used for the surface treatment is not particularly limited and preferably varies depending on the particle size of calcium carbonate. The fatty acid ester is generally used in an amount of about 1 to 20% of the weight of calcium carbonate.

The amount of precipitated calcium carbonate surface-treated with a fatty acid ester is preferably in the range of 50 to 150 parts by weight per 100 parts by weight of the urethane polymer.

Silica is classified into a hydrophilic grade and a hydrophobic grade, and both grades can be used.

Examples of plasticizers include dioctyl phthalate (DOP), dibutyl phthalate (DBP), dilauryl phthalate (DLP), dibutyl benzyl phthalate (BBP), dioctyl adipate, diisodecyl adipate, trioctyl phosphate, tris (chloroethyl) phosphate, tris(dichloropropyl) phosphate, adipic acid propylene glycol polyester, adipic acid butylene glycol polyester, epoxy stearic acid alkyl, and epoxidized soybean oil. These may be used singly or in a combination.

The antioxidant is an organic compound that prevents or suppresses the action of oxygen on autoxidative substances in light, heat, or the like. Examples of radical chain inhibitors include butylhydroxytoluene (BHT), butylated hydroxyanisole (BHA), and like phenol derivatives, diphenylamine, phenylenediamine, and like aromatic amines, triphenyl phosphite and like phosphites, and the like.

Pigments are classified into inorganic pigments and organic pigments. Examples of inorganic pigments include carbon black, titanium oxide, zinc oxide, ultramarine blue, red oxide, and like metal oxides, lithopone, and sulfur materials, hydrochlorides, and sulfates of lead, cadmium, iron, cobalt, and aluminum, and like. Examples of organic pigments include azo pigments, copper phthalocyanine pigments, and the like.

The silane coupling agent generally refers to an organosilicon compound having a functional group that can chemically bond inorganic materials, such as glass, silica, metal, and clay, and organic materials, such as polymers, which are incompatible with each other, the compound being represented by the following formula (1):

Y—CH₂SiX₃ Formula (1)

wherein X is a hydrolyzable substituent, such as alkoxy, acetoxy, isopropoxy, amino, or halogen, and reacts with inorganic materials; and Y is vinyl, epoxy, amino, methacryl, mercapto, or the like that easily reacts with organic materials.

The dispersing agent is a substance that disperses solids in the form of fine particles in liquid. Examples include sodium hexametaphosphate, condensed sodium naphthalenesulfonate, and surfactants.

In the composition of the present invention, a solvent may be used. Preferably, an aromatic hydrocarbon solvent may be used. Examples of aromatic solvents include xylene, toluene, and the like.

Such an adhesive is marketed under the trade name Terolan 1510 from Henkel.

3. Method for Producing Automotive Glass with Member

The method for producing automotive glass with a member according to the present invention comprises bonding an adherend 21 having a U-shaped cross section to an edge portion 20a of automotive glass 20 using an adhesive (hereinafter also referred to as “bonding step”) and curing the adhesive using a superheated steam generator 1 (hereinafter also referred to as “curing step”), thereby attaching the adherend 21 to the automotive glass 20. As described above, the superheated steam generator 1 includes a boiler part 2 for generating steam, a superheating unit 3 for superheating steam generated in the boiler part 2, and a superheated steam chamber 10 with the structure mentioned above for ejecting superheated steam to cure the adhesive. The curing step comprises covering the edge portion 20a of the automotive glass 20 together with the adherend 21, with the groove portion 111 of the superheated steam chamber 10, and spraying superheated steam to the adherend 21 from both sides of the automotive glass 20 from the superheated steam ejection portions 12.

The automotive glass with a member, adherend (door glass-fastening holder) 21, automotive glass 20, and adhesive are as described above.

### 3.1. Bonding Step

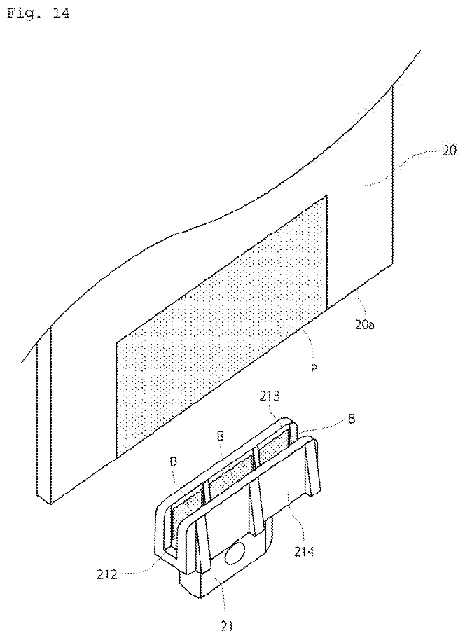

As shown in FIG. 14, the bonding step is a step of discharging the adhesive B, described above, to the U-shaped portion of the adherend (door glass-fastening holder) 21, i.e., the inside of a portion composed of the inner wall portion 213, the outer wall portion 214, and the bottom wall portion 212, and inserting the automotive glass 20 between the inner wall portion 213 and outer wall portion 214 of the adherend 21.

The method for applying the adhesive B to the adhesion surface of the adherend 21 is not particularly limited, and a known method may be used. Examples of application methods include application using a one-component dispenser, a one-component cartridge air gun, a two-component mixer, a two-component cartridge air gun, or an ink-jet coating machine, spray application, application using a brush, and the like. For example, when a two-component adhesive is used, a known two-component mixer may be used to discharge a two-component adhesive B to the adherend 21 and/or the adhesion surface of the adherend 21.

Before the adhesive is applied, a primer P may be applied to the adhesion surface of the adherend 21 and/or the adhesion surface of the automotive glass 20. The primer P may be applied using a known method as in application of the adhesive B.

A polyisocyanate composition, a silane coupling agent, or the like, which is generally called a “primer,” may be applied as the primer P to the adherend 21. However, there is no particular limitation on the primer P.

The silane coupling agent generally refers to an organosilicon compound having a functional group that can chemically bond inorganic materials, such as glass, silica, metal, and clay, and organic materials, such as polymers, which are incompatible with each other, the compound being represented by the following formula (2)

Y—(CH₂)ₙSiX₃ Formula (2)

wherein X and Y are the same as defined above.

The adhesive B may be applied to either the adhesion surface of the adherend 21 (U-shaped portion) or the adhesion surface of the automotive glass 20, or both. It is preferable that the adhesive is applied to the adhesion surface of the adherend 21 because the movable range of the adhesive coating device can be suppressed, and a small adhesive coating device is sufficient.

The adhesive B may be applied to only a portion of the adhesion surface of the adherend 21 if it is an amount sufficient for bonding the adherend 21.

The total amount of the adhesive B applied can be appropriately changed according to the mass, shape, etc. of the member to be attached to glass and is preferably 0.01 to 0.1 g/cm².

### 3.2. Curing Step

The curing step is a step of curing the adhesive B applied in the bonding step by using the superheated steam generator 1.

The automotive glass 20 to which the adherend (door glass-fastening holder) 21 is bonded at the edge portion 20a in the bonding step is set in the pedestal 31 so that the adherend 21 is located on the upper side. The pedestal 31 travels on the rail 30, and the edge portion 20a of the automotive glass 20 and the adherend 21 are inserted into the groove portion 111 of the superheated steam chamber 10. The edge portion 20a of the automotive glass 20 and the adherend 21 are thereby covered with the groove portion 111 of the superheated steam chamber 10.

In the superheated steam generator 1, steam generated in the boiler part 2 is supplied to the superheating unit 3 and superheated with a superheater in the superheating unit 3, thereby generating superheated steam. The pressure of steam supplied to the superheating unit 3 is preferably, for example, 0.1 to 0.3 MPa. The temperature of the superheater when steam is superheated in the superheating unit 3 is preferably 150 to 350° C., and particularly preferably 200 to 300° C.

Superheated steam generated in the superheating unit 3 is supplied to the superheated steam chamber 10 via the superheated steam ejection portions 12. The superheated steam ejection portions 12 are disposed on the opposite sides of the groove portion 111, and the ejection ports 121 are formed on the side toward the center of the groove portion 111. Thus, superheated steam is sprayed to the adherend 21 from both sides of the automotive glass 20 from the superheated steam ejection portions 12. The period of time for spraying superheated steam is preferably 10 to 120 seconds, more preferably 10 to 80 seconds, and particularly preferably 30 to 60 seconds. The adhesive B with which the adherend 21 is bonded to the automotive glass 20 is thereby cured.

The heaters 13 are provided in front of the ejection ports 121 of the superheated steam ejection portions 12. The temperature of superheated steam ejected from the ejection ports 121 is maintained with the heaters 13. The temperature of the heaters 13 is preferably 120 to 400° C., more preferably 140 to 350° C., and particularly preferably 170 to 250° C.

If necessary, in place of superheated steam, a dry gas can be made to flow into the superheated steam ejection portions 12.

With the present invention, the adhesive B can be cured in a short period of time by covering only an adhesion area with the superheated steam chamber 10 and spraying superheated steam from both sides. Moreover, since the adhesive B is cured by selectively spraying superheated steam to an adhesion area, the risk of impairing the appearance of the automotive glass 20 etc. can be avoided. In addition, it is only necessary for the superheated steam chamber 10 to cover the edge portion 20a of the automotive glass 20 and the adherend 21, thus eliminating the need for large equipment and enabling operation in less space than in the case of conventional techniques. This allows a significant reduction in energy costs and an increase in the efficiency of the work space in the process of attaching the adherend 21 to the automotive glass 20. Accordingly, the process of attaching the adherend 21 to the automotive glass 20 can be incorporated as a part of the manufacturing line for automobiles, making automobile manufacturing more efficient. Further, with the present invention, stable quality can be maintained irrespective of, for example, a difference in the curvature of the automotive glass 20 or the size and shape of a part to be attached.

One embodiment of the present invention has been described above; however, the present invention is not limited to this embodiment, and various modifications may be made without departing from the spirit of the present invention.

Next, the time until the adhesive B is cured in producing automotive glass with a member using the superheated steam generator 1 according to the present invention is verified.

As the superheated steam generator 1, a superheated steam generator for test pieces produced by Naomoto Corporation was used. This superheated steam generator 1 includes a boiler part 2 for generating steam, a superheating unit 3 for superheating steam generated in the boiler part 2, and a superheated steam chamber 10 for spraying superheated steam supplied from the superheating unit 3 to an object. The superheated steam chamber 10 includes superheated steam ejection portions 12 having ejection ports 121, and heaters 13 disposed on the side at which the ejection ports 121 open. The size of the superheated steam chamber 10 is 300 mm high, 300 mm wide, and 300 mm deep at the outer edge. The size of the groove portion 111 into which a test piece can be inserted is 220 mm high, 30 mm wide, and 300 mm deep.

### Production Example 1

### Molding of Door Glass-Fastening Holder Made of Polybutylene Terephthalate

Injection molding was performed using a polybutylene terephthalate resin (produced by Polyplastics Co. Ltd. (containing 30% glass fiber); grade name: Duranex 3300) by using a known method to prepare a door glass-fastening holder 21. The size of the door glass-fastening holder 21 was as follows: adhesion area: 45 mm×12 mm×2 surfaces; rib height: 0.5 mm.

### Production Example 2

Preparation of Test Piece with Door Glass-Fastening Holder

About 1.6 g of a thermosetting urethane adhesive B (produced by Henkel; trade name: Terolan 1510) was injected into the central portion of the door glass-fastening holder 21 made of polybutylene terephthalate, and the door glass-fastening holder 21 was bonded to a test piece (thickness: 4 am, area: 100×100 mm) of the same material as the automotive glass 20, thereby preparing a sample 1.

As a primer P, TEROSTAT-8521 (produced by Henkel) was used for the door glass-fastening holder 21, and TEROSTAT-8617H (produced by Henkel) was used for the automotive glass 20.

### Example 1

For the test piece with the door glass-fastening holder prepared in Production Example 2, curing by superheated steam was performed using the superheated steam generator 1 produced by Naomoto Corporation, and the time required for the adhesive to be completely cured was determined. At that time, the temperature of the superheater in the superheating unit 3 was set to 250° C., the temperature of the heaters 13 in the superheated steam chamber 10 was set to 200° C., and the discharge pressure of steam in the boiler part 2 was 0.2 MPa.

### Comparative Example 1

The time required for the adhesive B in the test piece with the door glass-fastening holder prepared in Production Example 2 to be completely cured in a hot air thermostat bath set at 100° C. was determined.

### Comparative Example 2

The time required for the adhesive B in the test piece with the door glass-fastening holder prepared in Production Example 2 to be completely cured in a hot air thermostat bath set at 200° C. was determined.

### Production Example 3

Preparation of Test Piece with Door Glass-Fastening Holder

About 1.6 g of a moisture-curable urethane adhesive B (produced by Yokohama Rubber Co., Ltd.; trade name: Hamatite WS-292A) was injected into the central portion of the door glass-fastening holder 21 made of polybutylene terephthalate, and the door glass-fastening holder 21 was bonded to a test piece (thickness: 4 am, area: 100×100 nm) of the same material as the automotive glass 20, thereby preparing a sample 2.

### Comparative Example 3

The test piece with the door glass-fastening holder prepared in Production Example 3 was aged in a constant temperature and humidity bath set at a temperature of 40° C. and a humidity of 60% RH, and the time required for the adhesive B to be completely cured was determined.

The results of Example 1 and Comparative Examples 1, 2, and 3 are shown below. These results show that the time required for the adhesive B to be completely cured was very short in Example 1.

TABLE 1

| | | | Comparative | | Comparative | | Comparative |
|---|---|---|---|---|---|---|---|
| | Example 1 | | Example 1 | | Example 2 | | Example 3 |
| Adhesive | Thermosetting | | Thermosetting | | Thermosetting | | Moisture- |
| | adhesive | | adhesive | | adhesive | | curable |
| | | | | | | | adhesive |
| | Polyurethane | | Polyurethane | | Polyurethane | | Polyurethane |
| Curing | Superheated | | Hot air | | Hot air | | Constant |
| method | steam | | thermostat | | thermostat | | temperature |
| | | | bath | | bath | | and humidity |
| | | | | | | | bath |
| Curing | 200° | C. | 100° | C. | 200° | C. | 40°C./60% RH |
| conditions | | | | | | | |
| Time to | 50 | seconds | 1 | hour | 15 | minutes | 78 hours |
| completely | | | | | | | |
| cure | | | | | | | |

### DESCRIPTION OF REFERENCE NUMERALS

1 Superheated steam generator
2 Boiler part
3 Superheating unit
10 Superheated steam chamber
11 Main body
11a Opening
111 Groove portion
12 Superheated steam ejection portion
16 Covering curtain
20 Automotive glass
20a Edge portion
21 Adherend
43 Air curtain

1. A superheated steam chamber for curing an adhesive for bonding an adherend having a U-shaped cross section to an edge portion of automotive glass, the superheated steam chamber comprising:
a main body having a groove portion capable of covering the edge portion of the automotive glass together with the adherend; and
one or more superheated steam ejection portions for ejecting superheated steam toward the groove portion, the one or more superheated steam ejection portions being disposed on both sides of the groove portion.

2. The superheated steam chamber according to claim 1, wherein the groove portion opens downwardly.

3. The superheated steam chamber according to claim 1, wherein an air curtain and/or a covering curtain is provided at the opening of the main body.

4. A method for producing automotive glass with a member, comprising:
bonding an adherend having a U-shaped cross section to an edge portion of automotive glass using an adhesive; and
curing the adhesive using a superheated steam generator, thereby attaching the adherend to the automotive glass,
the superheated steam generator comprising a boiler part for generating steam, a superheating unit for superheating steam generated in the boiler part, and the superheated steam chamber according to claim 1 for ejecting superheated steam supplied from the superheating unit,
the adhesive curing step comprising covering the edge portion of the automotive glass together with the adherend, with the groove portion of the superheated steam chamber, and spraying superheated steam to the adherend from both sides of the automotive glass from the superheated steam ejection portions.

5. The method according to claim 4, wherein the superheated steam chamber comprises one or more heaters, and the temperature of the one or more heaters is 120 to 400° C.

6. The method according to claim 4, wherein the superheated steam is sprayed for 10 to 120 seconds.

7. The superheated steam chamber according to claim 2, wherein an air curtain and/or a covering curtain is provided at the opening of the main body.

8. The method according to claim 4, wherein the groove portion of the superheated steam chamber opens downwardly.

9. The method according to claim 4, wherein an air curtain and/or a covering curtain is provided at the opening of the main body of the superheated steam chamber.

10. The method according to claim 8, wherein an air curtain and/or a covering curtain is provided at the opening of the main body of the superheated steam chamber.

11. The method according to claim 8, wherein the superheated steam chamber comprises one or more heaters, and the temperature of the one or more heaters is 120 to 400° C.

12. The method according to claim 9, wherein the superheated steam chamber comprises one or more heaters, and the temperature of the one or more heaters is 120 to 400° C.

13. The method according to claim 10, wherein the superheated steam chamber comprises one or more heaters, and the temperature of the one or more heaters is 120 to 400° C.

14. The method according to claim 8, wherein the superheated steam is sprayed for 10 to 120 seconds.

15. The method according to claim 9, wherein the superheated steam is sprayed for 10 to 120 seconds.

16. The method according to claim 10, wherein the superheated steam is sprayed for 10 to 120 seconds.

17. The method according to claim 5, wherein the superheated steam is sprayed for 10 to 120 seconds.

18. The method according to claim 11, wherein the superheated steam is sprayed for 10 to 120 seconds.

19. The method according to claim 12, wherein the superheated steam is sprayed for 10 to 120 seconds.

20. The method according to claim 13, wherein the superheated steam is sprayed for 10 to 120 seconds.
